(19) United States
(12) Patent Application Publication
(10) Pub. No.: US 2006/0278683 A1
(43) Pub. Date: Dec. 14, 2006

(54) Clamp device

(75) Inventors: Toshiaki Otsuka, Kawasaki (JP); Tadashi Inoue, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/221,886

(22) Filed: Sep. 9, 2005

(30) Foreign Application Priority Data
Jun. 8, 2005 (JP) 2005-168898

(51) Int. Cl. B23K 37/00

(52) U.S. Cl. 228/44.3

(57) ABSTRACT

A clamp device includes a base, a X direction positioning pin positioning a work piece in a X direction, and a Y direction positioning pin positioning the work piece in a Y direction. A X direction arm moves the work piece toward the X direction positioning pin. A Y direction arm moves the work piece toward the Y direction positioning pin. An arm drive mechanism performs moving actuation of the X direction arm and moving actuation of the Y direction arm. The X direction arm and the Y direction arm are constructed such that the arm drive mechanism performs the moving actuation of the Y direction arm and the moving actuation of the X direction arm with a time difference being provided between the pressing of the work piece against the Y direction positioning pin and the pressing of the work piece against the X direction positioning pin.

### CROSS-REFERENCE TO RELATED APPLICATION

This application is based upon and claims the benefit of priority of Japanese Patent Application No. 2005-168898, filed on Jun. 8, 2005, the entire contents of which are herein incorporated by reference.

### BACKGROUND OF THE INVENTION

1. Field of the Invention

The present invention generally relates to a clamp device, and more particularly to a clamp device which positions a work piece by pressing the work piece to positioning pins in both the X direction and the Y direction of a base.

2. Description of the Related Art

Generally, in the assembly line of various electrical and electric devices (for example, a hard disk drive unit), it is necessary to attach the product being assembled (work piece) to an assembling apparatus in a condition in which the product is positioned correctly.

For this reason, in each assembling apparatus, a clamp device which positions and clamps a work piece to a predetermined location in the assembling apparatus is provided.

There are various proposed structures of clamp device. What is proposed in many cases is a clamp device which uses three positioning pins 2A-2C which are provided on base 1 as shown in FIG. 1. See Japanese Laid-Open Patent Application No. 06-218695. The clamp device of FIG. 1 comprises two Y direction positioning pins 2A and 2B provided to position the work piece in the Y direction, and one X direction positioning pin 2C provided to position the work piece in the X direction.

In order to position work piece 3 using the positioning pins 2A-2C, positioning of work piece 3 in the Y direction is performed first by pressing work piece 3 against the Y direction positioning pins 2A and 2B. Then, while the condition of work piece 3 being pressed against the Y direction positioning pins 2A and 2B is maintained, work piece 3 is moved in the X1 direction so that work piece 3 is pressed against the X direction positioning pin 2C. Accordingly, the clamp device of FIG. 1 is constructed to perform positioning of work piece 3 in both the X direction and the Y direction.

FIG. 2 shows the composition of a first conventional example of the clamp device, and FIG. 3A to FIG. 3C show the composition of a second conventional example of the clamp device.

In FIG. 2 and FIG. 3A to FIG. 3C, the elements which are. essentially the same as corresponding elements in FIG. 1 are designated by the same reference numerals, and a description thereof will be omitted.

The clamp device shown in FIG. 2 comprises two cylinders 4 and 5. The Y direction cylinder 4 functions to press work piece 3 against the Y direction positioning pins 2A and 2B. And the X direction cylinder 5 functions to press work piece 3 against the X direction positioning pin 2C.

A concrete operation of this clamp device will be explained. After work piece 3 is laid on base 1, work piece 3 is first pressed against the Y direction positioning pins 2A and 2B by driving the Y direction cylinder 4. Then, while the condition in which work piece 3 is pressed against the Y direction positioning pins 2A and 2B by the Y direction cylinder 4 is maintained, the X direction cylinder 5 is driven so that work piece 3 is pressed against the X direction positioning pin 2C. Accordingly, work piece 3 can be positioned at the predetermined location on base 1 by using each of the positioning pins 2A-2C.

The clamp device shown in FIG. 3A to FIG. 3C comprises a single cylinder 6. This cylinder 6 functions to press work piece 3 against the Y direction positioning pins 2A and 2B, and concurrently functions to press work piece 3 against the X direction positioning pin 2C. The cylinder 6 has the two functions mentioned above (this cylinder 6 will be called combination cylinder 6).

And the combination cylinder 6 is provided with a pressing member having has the right-angled groove at its leading edge, and this right-angled groove is engaged with the corner part of work piece 3 when work piece 3 is pressed by the combination cylinder 6.

A concrete operation of this clamp device will be explained. After work piece 3 is laid on base 1, the upper-left corner part of work piece 3 is pressed in the diagonal direction of work piece 3 by driving the combination cylinder 6. The pressing force of combination cylinder 6 to press work piece 3 is decomposed into X-direction component force and Y-direction component force. Thus, work piece 3 is pressed against the Y direction positioning pins 2A and 2B by the Y-direction component force, and work piece 3 is pressed against the X direction positioning pin 2C by the X-direction component force.

Thereby, as shown in FIG. 3A, work piece 3 can be positioned at the predetermined location on base 1 by each of the positioning pins 2A-2C.

However, with the clamp device of FIG. 2, the two cylinders 4 and 5 are required for pressing work piece 3 against each positioning pin 2A-3C, and the number of components will increase. Moreover, it is necessary to provide a time difference in driving of the Y direction cylinder 4 and the X direction cylinder 5 because it is necessary to provide a time difference between the pressing of work piece 3 to the Y direction positioning pins 2A and 2B and the pressing of work piece 3 to the X direction positioning pin 2C.

For this reason, a control circuit which drives the Y direction cylinder 4 and the X direction cylinder 5 separately is needed, and there is a problem that the structure of the clamp device will be complicated.

On the other hand, with the clamp device shown in FIG. 3A to FIG. 3C, only one combination cylinder 6 is used, and reduction of the number of components of the clamp device and simplification of the structure can be attained. However, if the drive force and angle by which combination cylinder 6 pushes work piece 3 are deviated from the predetermined force and the determined direction, it becomes impossible to perform appropriate positioning.

Specifically, in the example shown in FIG. 3B, the drive force and angle by which combination cylinder 6 pushes work piece 3 are improper, and the moment to rotate work piece 3 counterclockwise occurs as indicated by the arrow in FIG. 3B. In this case, work piece 3 is separated from the Y direction positioning pin 2A, and it is difficult to perform proper positioning.

In the example shown in FIG. 3C, the drive force and angle by which combination cylinder 6 pushes work piece 3 are improper, and the moment to rotate work piece 3 clockwise occurs as indicated by the arrow in FIG. 3C. In this case, work piece 3 is separated from the Y direction positioning pin 2B, and it is also difficult to perform appropriate positioning.

### SUMMARY OF THE INVENTION

An object of the present invention is to provide an improved clamp device in which the above-mentioned problems are eliminated.

Another object of the present invention is to provide a clamp device which has a simple structure and can perform appropriate positioning stably.

In order to achieve the above-mentioned objects, the present invention provides a clamp device which includes a base, a X direction positioning pin provided on the base for positioning a work piece on the base in a X direction, and a Y direction positioning pin provided on the base for positioning the work piece on the base in a Y direction, the clamp device clamping the work piece by pressing the work piece against the X direction positioning pin and against the Y direction positioning pin in order to perform positioning of the work piece, the clamp device comprising: a X direction arm moving the work piece toward the X direction positioning pin; a Y direction arm moving the work piece toward the Y direction positioning pin; and an arm drive mechanism performing moving actuation of the X direction arm and moving actuation of the Y direction arm, wherein the X direction arm and the Y direction arm are constructed such that the arm drive mechanism performs the moving actuation of the Y direction arm and the moving actuation of the X direction arm with a time difference being provided between the pressing of the work piece against the Y direction positioning pin and the pressing of the work piece against the X direction positioning pin.

According to the above-mentioned invention, moving actuation of the work piece towards the X direction positioning pin is performed by the X direction arm, moving actuation of the work piece towards the Y direction positioning pin is performed by the Y direction arm, and the X direction arm and the Y direction arm are constructed such that the arm drive mechanism performs the moving actuation of the Y direction arm and the moving actuation of the X direction arm with a time difference being provided between the pressing of the work piece against the Y direction positioning pin and the pressing of the work piece against the X direction positioning pin. It is possible to perform appropriate positioning of the work piece stably.

Moreover, the time difference is provided between the pressing of the work piece against the Y direction positioning pin and the pressing of the work piece against the X direction positioning pin, and it is not necessary to use a control circuit which performs complicated control processing of the arm drive mechanism. It is possible that the work piece is first positioned in one of the X direction and the Y direction by using a corresponding one of the X direction arm and the Y direction arm, and then positioning of the work piece in the other of the X direction and the Y direction is performed by using the other direction arm. Therefore, it is possible to perform appropriate positioning of the work piece safely with simple structure.

Moreover, the above-mentioned clamp device of the invention may be configured so that a freely rotatable roller is disposed on each of the X direction positioning pin and the Y direction positioning pin.

According to the above-mentioned invention, the freely ratable roller is disposed on each of the X direction positioning pin and the Y direction positioning pin, and movement of the work piece toward each pin can be carried out smoothly, and improvement in positioning accuracy can be attained.

Moreover, the above-mentioned clamp device of the invention may be configured so that the X direction arm is rotatably disposed on the base, the Y direction arm is rotatably disposed on the base, and the arm drive mechanism performs moving actuation of an edge of each of the X direction arm and the Y direction arm where a roller is disposed on each of the X direction arm and the Y direction arm, and performs moving actuation of an opposite edge of each of the X direction arm and the Y direction arm which is opposite to the edge where the roller of each arm is disposed.

According to the above-mentioned invention, the arm drive mechanism performs moving actuation of the edge of each of the X direction arm and the Y direction arm where the roller is disposed, and performs moving actuation of the opposite edge of each of the X direction arm and the Y direction arm. The center of rotation of each arm is suitably selected, and the amount of movement of the edge can be enlarged even if the amount of movement of the opposite edge is small. Therefore, each of the X direction arm and the Y direction arm can be moved certainly while miniaturization of the arm drive mechanism is attained.

Moreover, the above-mentioned clamp device of the invention may be configured so that the arm drive mechanism comprises: a X direction engaging pin which is engaged with the opposite edge of the X direction arm; a Y direction engaging pin which is engaged with the opposite edge of the Y direction arm; a bracket in which the X direction engaging pin and the Y direction engaging pin are disposed; and a drive unit which moves the bracket along a straight line.

According to the above-mentioned invention, the bracket in which the X direction engaging pin and the Y direction engaging pin are disposed is moved along a straight line by the drive unit of the arm drive mechanism, and the X direction arm and the Y direction arm can be driven through each engaging pin. It is possible that the time difference is provided between the pressing of the work piece against the Y direction positioning pin and the pressing of the work piece against the X direction positioning pin, and the X direction arm and the Y direction arm can be driven certainly by using the arm drive mechanism of a simple structure.

Moreover, the above-mentioned clamp device of the invention may be configured so that the clamp device further comprises a X direction spring disposed between the base and the X direction arm to perform rotating actuation of the X direction arm to cause the work piece to move toward the X direction positioning pin; and a Y direction spring disposed between the base and the Y direction arm to perform rotating actuation of the Y direction arm to cause the work piece to move toward the Y direction positioning pin.

According to the above-mentioned invention, rotating actuation of the X direction arm to cause the work piece to move toward the X direction positioning pin is performed by the X direction spring, and rotating actuation of the Y direction arm to cause the work piece to move toward the Y direction positioning pin is performed by the Y direction spring. It is not necessary for the arm drive mechanism to generate a force to move each arm toward the work piece, and it is possible to attain a simple structure of the arm drive mechanism.

Moreover, the above-mentioned clamp device of the invention may be configured so that a first roller is disposed at the edge of the X direction arm where the work piece is pressed against the X direction positioning pine, and a second roller is disposed at the edge of the Y direction arm where the work piece is pressed against the Y direction positioning pin. Furthermore, the above-mentioned clamp device of the invention may be configured so that the drive unit of the arm drive mechanism comprises an air cylinder.

According to the clamp device of the invention, it is possible to perform appropriate positioning of a work piece stably by using a small number of components.

### BRIEF DESCRIPTION OF THE DRAWINGS

Other objects, features and advantages of the present invention will be apparent from the following detailed description when read in conjunction with the accompanying drawings.

FIG. 1 is a diagram for explaining the basic principle of positioning a work piece.

FIG. 2 is a diagram for explaining the first conventional example of a clamp device.

FIG. 3A, FIG. 3B and FIG. 3C are diagrams for explaining the second conventional example of a clamp device.

FIG. 4 is a perspective view showing the clamp device in an embodiment of the invention.

FIG. 5 is a diagram for explaining the operation of the clamp device in the embodiment of the invention when it is in the condition in which both X and Y arms are separated from a work piece.

FIG. 6 is a diagram for explaining the operation of the clamp device in the embodiment of the invention when it is in the condition in which positioning of the work piece in the Y direction is performed by Y arm.

FIG. 7 is a diagram for explaining the operation of the clamp device in the embodiment of the invention when it is in the condition in which positioning of the work piece in both the X direction and the Y direction is performed by X and Y arms.

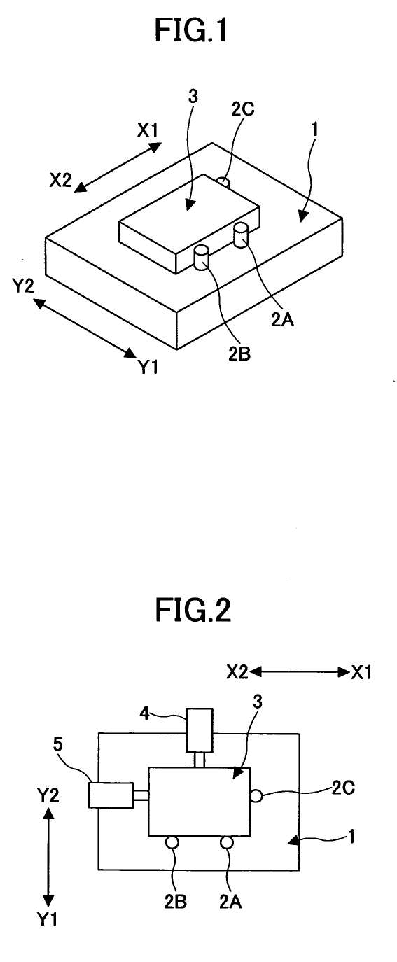

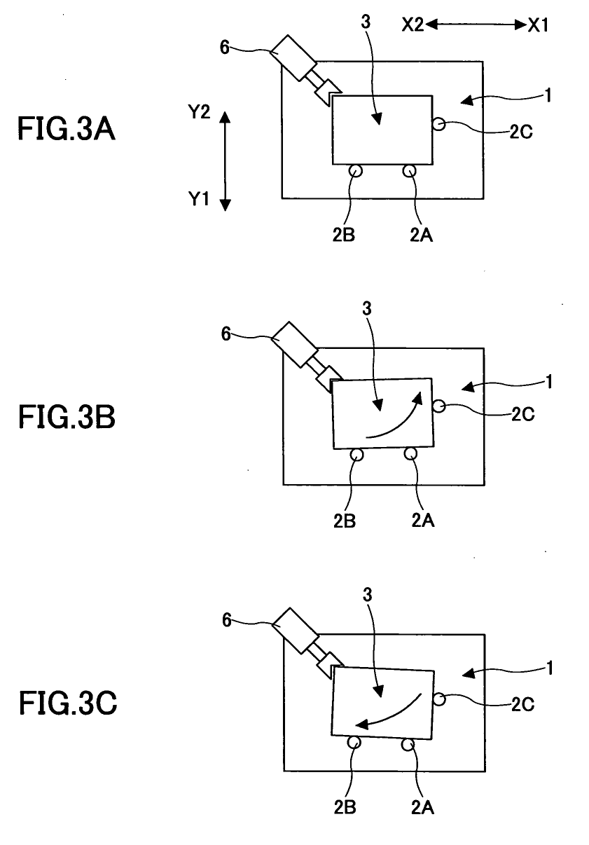

### DETAILED DESCRIPTION OF PREFERRED EMBODIMENTS

A description will now be given of the preferred embodiments of the invention with reference to the accompanying drawings.

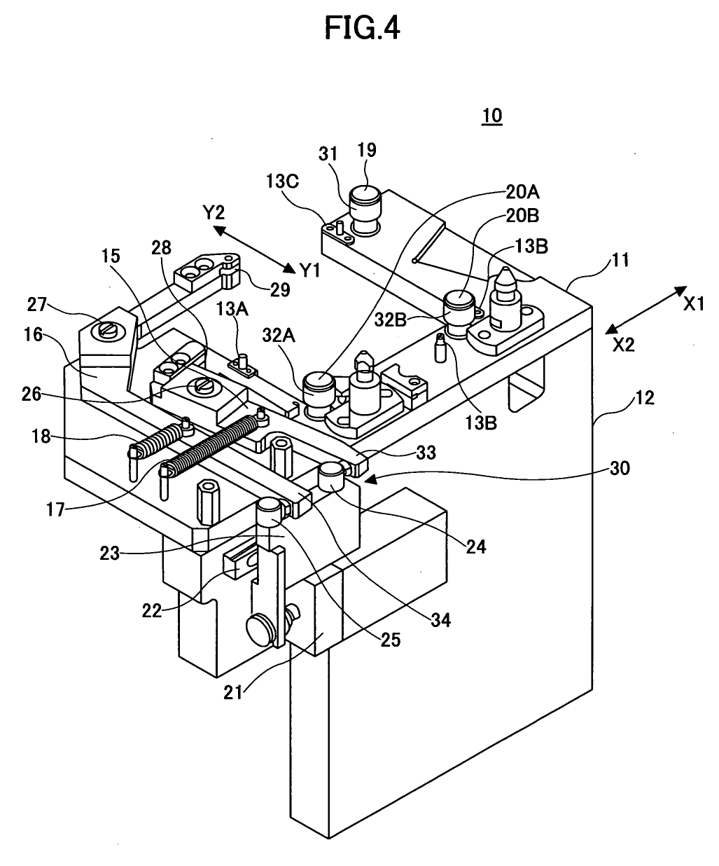

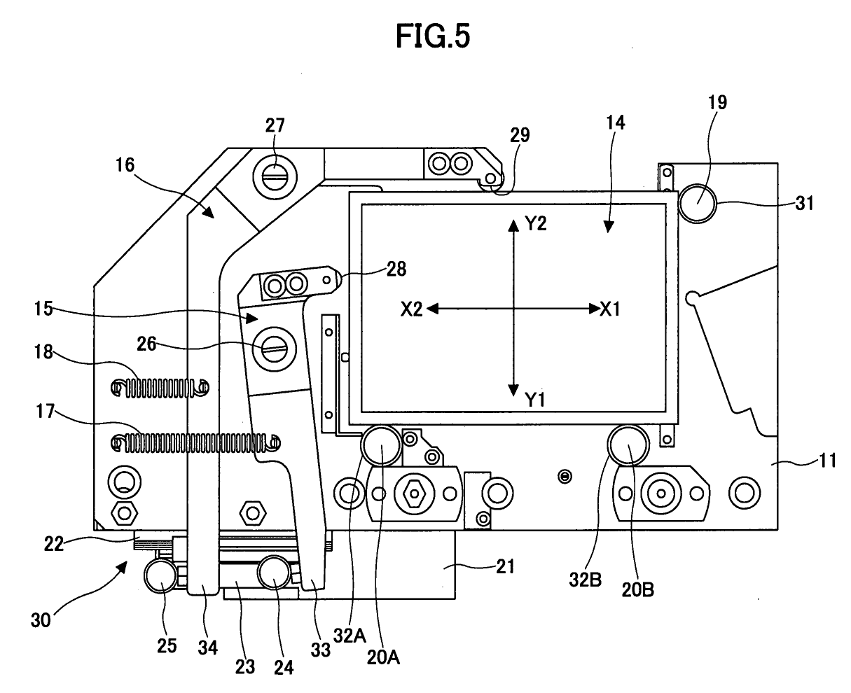

FIG. 4 and FIG. 5 show the clamp device 10 in one embodiment of the invention. FIG. 4 is a perspective view showing the whole composition of the clamp device 10, and FIG. 5 is a plan view of the clamp device 10 of FIG. 4. What is shown in FIG. 5 is the condition in which work piece 14 which is a component being positioned is laid on the clamp device 10.

The clamp device 10 is generally comprised of the base 11, the X direction arm 15 (called X arm 15), the Y direction arm 16 (called Y arm 16), the X direction spring 17, the Y direction spring 18, the X direction positioning pin 19 (called X positioning pin 19), the Y direction positioning pins 20A and 20B (called Y positioning pins 20A and 20B), and the arm drive mechanism 30.

Base 11 is a plate-like board and disposed on the upper part of stage 12. In base 11, an opening is formed in the portion where work piece 14 is loaded. For this reason, a plan view of the base 11 shows a generally U-shaped configuration.

In the following description, it is assumed that the right/left direction in FIG. 5 is X1/X2 direction, and the up/down direction in FIG. 5 is Y2/Y1 direction, respectively.

X arm 15 is rotatably disposed on base 11 so that X arm 25 can be rotated on base 11 around support shaft 26 which is embedded in base 11 and used as a support point of the rotation. X roller 28 is disposed at one edge of X arm 15, and this roller 28 is constructed so that it faces the side surface of work piece 14 laid on base 11 on the side of the X2 direction.

Moving actuation of the edge where the roller 28 of X arm 15 is disposed and the edge 33 on the opposite side thereof is carried out by arm drive mechanism 30, which will be described later.

Y arm 16 is rotatably disposed on base 11 so that Y arm 16 can be rotated on base 11 around support shaft 27 which is embedded in base 11 and used as a support point of the rotation. Y roller 29 is disposed at one edge of Y arm 16, and this roller 29 is constructed so that it faces the side surface of work piece 14 laid on base 11 on the side of the Y2 direction.

Moving actuation of the edge where the roller 29 of Y arm 16 is disposed and the edge 34 on the opposite side thereof is carried out by arm drive mechanism 30, which will be described later.

X direction spring 17 is disposed under tension between base 11 and X arm 15. This X direction spring 17 performs rotating actuation of X arm 15 around support shaft 26 clockwise. However, when edge 33 contacts X engaging pin 24 which is provided in arm drive mechanism 30, rotation of X arm 15 is stopped.

Y direction spring 18 is disposed under tension between base 11 and Y arm 16. This Y direction spring 18 performs rotating actuation of Y arm 16 around support shaft 27 clockwise. However, when edge 34 contacts Y engaging pin 25 which is provided in arm drive mechanism 30, rotation of Y arm 16 is stopped.

X positioning pin 19 is embedded in base 11. This X positioning pin 19 is disposed at the location where it faces the side surface of work piece 14 on the side of X1 direction when work piece 14 is laid on base 11. Roller 31 which is freely rotatable is disposed on the part of X positioning pin 19 which comes in contact with the side surface of work piece 14.

In this embodiment, the structure in which only one X positioning pin 19 is disposed is considered. Alternatively, two or more X positioning pins 19 may be disposed.

Y positioning pins 20A and 20B are embedded in base 11, and these positioning pins are arranged so that they are separate from each other by a predetermined distance in the X1/X2 direction. The Y positioning pins 20A and 20B are disposed at the locations where they face the side surface of work piece 14 on the side of Y1 direction when work piece 14 is laid on base 11. Rollers 32A and 32B which are freely rotatable are disposed on the parts of Y positioning pins 20A and 20B respectively which come in contact with the side surface of work piece 14.

Positioning of work piece 14 in the X direction and the Y direction is performed by using the three positioning pins 19, 20A and 20B mentioned above. Base pins 13A, 13B and 13C are disposed in the neighborhood of the locations of the positioning pins 20A, 20B and 19.

Base pins 13A to 13C are embedded in base 11, and they are constructed with high precision so that they have the same height on base 11. The back surface of work piece 14 is laid on the base pins 13A-13C, and positioning of work piece 14 in the vertical direction (which is perpendicular to the X and Y surfaces of base 11), i.e., positioning of work piece 14 in the height direction to base 11, is performed by using the base pins 13A to 13C. Movement of work piece 14 on the base pins 13A to 13C is possible.

The arm drive mechanism 30 is generally comprised of air cylinder 21, bracket 23, X engaging pin 24, and Y engaging pin 25. Air cylinder 21 serves as a source of actuation of X arm 15 and Y arm 16, and bracket 23 is attached to the output shaft of air cylinder 21.

The output shaft of air cylinder 21 performs straight-line movement in the X1/X2 direction indicated by the arrow in FIG. 4. When a compressed air from an air compressor (which is not illustrated) is supplied to air cylinder 21, the output shaft of air cylinder 21 moves in the X2 direction, and the output shaft of air cylinder 21 moves in the X1 direction by releasing the compressed air from air cylinder 21.

A control valve which is not illustrated is provided between the air compressor and air cylinder 21, and the drive control of air cylinder 21 is carried out by using the control valve.

Bracket 23 is attached to straight-line guide member 22 which is provided in stage 12. By the use of straight-line guide member 22, straight-line movement of bracket 23 in the X1/X2 direction with high accuracy is possible. Therefore, when the driving is performed by air cylinder 21, bracket 23 is guided by straight-line guide member 22 and moved in the X1/X2 direction smoothly and with high precision.

X engaging pin 24 and Y engaging pin 25 are embedded in the top surface of bracket 23. X engaging pin 24 is disposed so that it faces the edge 33 of X arm 15. Specifically, clockwise rotation of X arm 15 is performed by the X direction spring 17 as mentioned above, and X engaging pin 24 is disposed at the location (on the left side of edge 33 in FIG. 5) so that it can stop this rotation.

In this embodiment, both the engaging pins 24 and 25 are disposed on bracket 23, and straight-line movement of the engaging pins 24 and 25 can be performed simultaneously. It is possible to simplify the structure of arm drive mechanism 30.

Y engaging pin 25 is disposed so that it faces the edge 34 of Y arm 16. Specifically, clockwise rotation of Y arm 16 is performed the Y direction spring 18 as mentioned above, and Y engaging pin 25 is disposed at the location (on the left side of edge 34 in FIG. 5) so that it can stop this rotation.

The condition in which work piece 14 is not laid on the clamp device 10 is supposed. In other words, the condition in which roller 28 of X arm 15 and roller 29 of Y arm 16 serve as a free end is supposed. In this condition, the actuation of X direction spring 17 causes the edge 33 of X arm 15 to contact X engaging pin 24, and the actuation of Y direction spring 18 causes the edge 34 of Y arm 16 to contact Y engaging pin 25. And the driving of air cylinder 21 causes X engaging pin 24 and Y engaging pin 25 to move in the X1/X2 direction through bracket 23, so that X arm 15 and Y arm 16 are rotated with the movement of each of the engaging pins 24 and 25.

Next, with reference to FIG. 5 through FIG. 7, the operation of positioning work piece 14 which is performed by the above-described clamp device 10 will be explained.

FIG. 5 shows the condition of the clamp device 10 immediately after work piece 14 is laid on the clamp device 10 but the positioning of work piece 14 is not yet carried out.

Work piece 14 is laid on the base pins 13A-13C which are embedded in base 11. This means that positioning of work piece 14 in the vertical direction perpendicular to the top surface of base 11 is completed. However, immediately after work piece 14 is laid on the base pins 13A-13C, positioning of work piece 14 in the X direction and the Y direction is not performed.

Air cylinder 21 which constitutes part of arm drive mechanism 30 is in a condition in which bracket 23 is moved to the end in the X1 direction indicated by the arrow X1, and the output shaft of air cylinder 21 is contracted. Thus, in this condition, each of the engaging pins 24 and 25 fixed to bracket 23 are also moved to the end in the X1 direction indicated by the arrow X1.

Moreover, in this condition, X arm 15 and Y arm 16 are rotated to the end in the counterclockwise direction by the movement of each of the engaging pins 24 and 25 to the end in the X direction.

As mentioned above, when the arms 15 and 16 are rotated to the end in the counterclockwise direction, each of the rollers 28 and 29 provided on the arms 15 and 16 is separated from work piece 14.

After work piece 14 is laid on the clamp device 10 as mentioned above, the arm drive mechanism 30 starts operation, and the output shaft of air cylinder 21 is expanded so that bracket 23 is moved in the X2 direction. In connection with this, each of the engaging pins 24 and 25 fixed to bracket 23 is also moved in the X2 direction.

Moreover, since each of the engaging pins 24 and 25 is moved in the X2 direction, X arm 15 and Y arm 16 are actuated by the springs 17 and 18 so that clockwise rotation of each of X arm 15 and Y arm 16 is carried out.

With the rotation of each of the arms 15 and 16, rollers 28 and 29 provided at the edges of the arms 15 and 16 are moved to approach work piece 14.

It is possible that the amount of movement of the edges (the rollers 28 and 29) of the arms 15 and 16 relative to the amount of movement of each of the engaging pins 24 and 25 be adjusted by changing the respective locations of support shafts 26 and 27 arranged in arms 15 and 16, and changing the respective distances between support shafts 26 and 27 and the edges of arms 15 and 16.

In this embodiment, the locations of support shafts 26 and 27 arranged in arms 15 and 16, and the distances between support shafts 26 and 27 and the edges of arms 15 and 16 are adjusted such that the timing at which roller 29 provided in Y arm 16 contacts the side surface of work piece 14 on the side of the Y2 direction is earlier than the timing at which roller 28 provided in X arm 15 contacts the side surface of work piece 14 on the side of the X2 direction.

Therefore, when the driving of air cylinder 21 causes the engaging pins 24 and 25 to move in the X2 direction and clockwise rotation of X arm 15 and Y arm 16 is performed as mentioned above, roller 29 provided in Y arm 16 contacts the side surface of work piece 14 on the side of the Y2 direction at an earlier timing so that work piece 14 is pressed against Y positioning pins 20A and 20B. Thereby, positioning of work piece 14 in the Y direction is carried out.

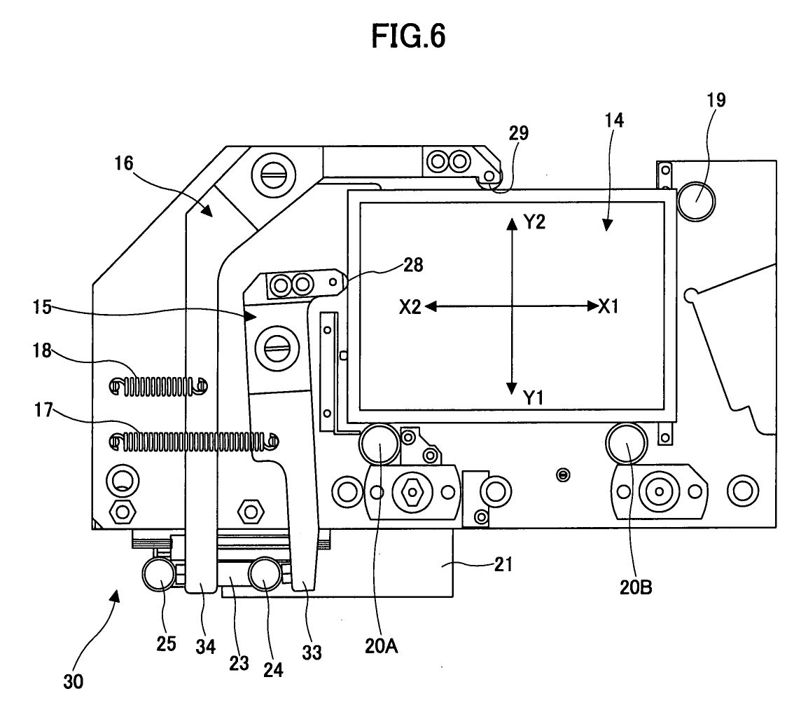

FIG. 6 shows the condition of the clam device 10 in which work piece 14 is pressed against Y positioning pins 20A and 20B by Y arm 16. In this condition, X arm 15 is separated from work piece 14, and such condition is maintained.

When Y engaging pin 25 moves in the X2 direction, Y engaging pin 25 is separated from the edge 34 of Y arm 16. Even if Y arm 16 is separated from Y engaging pin 25, roller 29 contacts the side surface of work piece 14. For this reason, the clockwise rotation of Y arm 16 by the Y direction spring 18 is stopped. In addition, the elastic force of the Y direction spring 18 functions to press work piece 14 against Y positioning pins 20A and 20B, and positioning of work piece 14 in the Y1/Y2 direction can be maintained.

When the driving of air cylinder 21 causes the engaging pins 24 and 25 to further move in the X2 direction, roller 28 provided in X arm 15 contacts the side surface of work piece 14 on the side of the X2 direction so that work piece 14 is pressed against X positioning pin 19. Thereby, positioning of work piece 14 in the X direction is carried out.

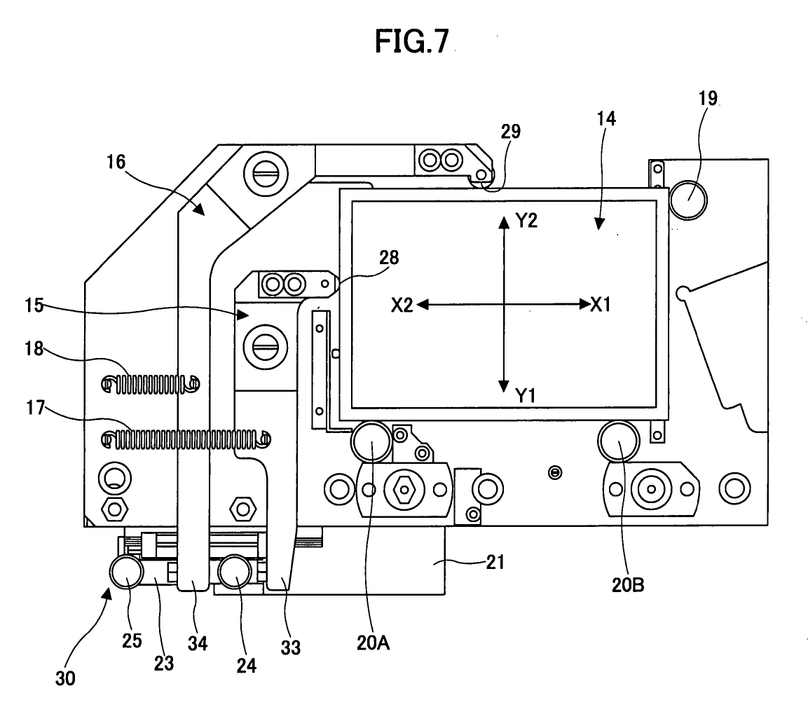

FIG. 7 shows the condition of the clam device 10 in which work piece 14 is pressed against X positioning pin 19 by X arm 15.

In this condition, Y arm 16 presses work piece 14 against Y positioning pins 20A and 20B, and such condition is maintained. Therefore, work piece 14 is in the condition that positioning pf work piece 14 in both the X direction and the Y direction is completed.

When X engaging pin 24 moves in the X2 direction, X engaging pin 24 is separated from the edge 33 of X arm 15. Even if X arm 15 is separated from X engaging pin 24, roller 28 contacts the side surface of work piece 14. Thus, the clockwise rotation of X arm 15 by the X direction spring 17 is stopped.

The elastic force of X direction spring 17 functions to press work piece 14 against X positioning pin 19, and positioning of work piece 14 in the X1/X2 direction is maintained.

As mentioned above, the condition in which work piece 14 is pressed against Y positioning pins 20A and 20B is maintained by the elastic force of the Y direction spring 18. After the engaging pins 24 and 25 are separated from arms 15 and 16, the elastic force of X direction spring 17 and the elastic force of Y direction spring 18 cause the arms 15 and 16 to press work piece 14 against the positioning pins 19, 20A, and 20B. Therefore, work piece 14 is clamped by the arms 15 and 16 while the condition in which work piece 14 is positioned is maintained.

In the above-described embodiment, the arms 15 and 16 are used not only for positioning of work piece 14 but also for clamping of work piece 14, and it is not necessary to include a clamping device which clamps work piece 14 in the arm drive mechanism 30. Therefore, simple structure of the arm drive mechanism 30 can be attained.

What is necessary in order to cancel positioning of work piece 14 by the arms 15 and 16 is just to carry out the above-described operation of the clamp device 10 in a reverse manner.

According to the clamp device 10 of the above-described embodiment, moving actuation of work piece 14 is first carried out by Y arm 16 so that work piece 14 is pressed against Y positioning pins 20A and 20B. After a predetermined time is elapsed thereafter, moving actuation of work piece is carried out by X arm 15 so that work piece 14 is pressed against X positioning pin 19 so that positioning of work piece 14 in both the X direction and the Y direction is performed. With a time difference between the pressing of work piece 14 against positioning pins 20A and 20B and the pressing of work piece 14 against positioning pin 19 being provided, positioning of work piece 14 is carried out in a condition in which work piece 14 is pressed against positioning pins 19, 20A and 20B. Therefore, it is possible to perform appropriate position of work piece 14 stably.

According to the clamp device 10 of the above-described embodiment, work piece 14 can be positioned in both the X direction and the Y direction with a time difference being provided, and it is not necessary to use a control circuit. Therefore, it is possible to perform positioning of work piece 14 stably with simple structure.

In addition, the locations of support shafts 26 and 27 which are the centers of rotation of the arms 15 and 16 are suitably selected, and even if the amount of movement of the edges 33 and 34 is small, the amount of movement of the rollers 28 and 29 can be enlarged. Miniaturization of arm drive mechanism 30 can be attained, and it is possible to adjust the amount of movement of the arms 15 and 16 suitably.

The present invention is not limited to the above-described embodiments, and variations and modifications may be made without departing from the scope of the present invention.

What is claimed is:

1. A clamp device which includes a base, a X direction positioning pin provided on the base for positioning a work piece on the base in a X direction, and a Y direction positioning pin provided on the base for positioning the work piece on the base in a Y direction, the clamp device clamping the work piece by pressing the work piece against the X direction positioning pin and against the Y direction positioning pin in order to perform positioning of the work piece, the clamp device comprising:
a X direction arm moving the work piece toward the X direction positioning pin;
a Y direction arm moving the work piece toward the Y direction positioning pin; and
an arm drive mechanism performing moving actuation of the X direction arm and moving actuation of the Y direction arm,
wherein the X direction arm and the Y direction arm are constructed such that the arm drive mechanism performs the moving actuation of the Y direction arm and the moving actuation of the X direction arm with a time difference being provided between the pressing of the work piece against the Y direction positioning pin and the pressing of the work piece against the X direction positioning pin.

2. The clamp device according to claim 1 wherein a freely rotatable roller is disposed on each of the X direction positioning pin and the Y direction positioning pin.

3. The clamp device according to claim 1 wherein the X direction arm is rotatably disposed on the base, the Y direction arm is rotatably disposed on the base, and the arm drive mechanism performs moving actuation of an edge of each of the X direction arm and the Y direction arm where a roller is disposed on each of the X direction arm and the Y direction arm, and performs moving actuation of an opposite edge of each of the X direction arm and the Y direction arm which is opposite to the edge where the roller of each arm is disposed.

4. The clamp device according to claim 3 wherein the arm drive mechanism comprises:
a X direction engaging pin which is engaged with the opposite edge of the X direction arm;
a Y direction engaging pin which is engaged with the opposite edge of the Y direction arm;
a bracket in which the X direction engaging pin and the Y direction engaging pin are disposed; and
a drive unit which moves the bracket along a straight line.

5. The clamp device according to claim 3 further comprising:
a X direction spring disposed between the base and the X direction arm to perform rotating actuation of the X direction arm to cause the work piece to move toward the X direction positioning pin; and
a Y direction spring disposed between the base and the Y direction arm to perform rotating actuation of the Y direction arm to cause the work piece to move toward the Y direction positioning pin.

6. The clamp device according to claim 3 wherein a first roller is disposed at the edge of the X direction arm where the work piece is pressed against the X direction positioning pine, and a second roller is disposed at the edge of the Y direction arm where the work piece is pressed against the Y direction positioning pin.

7. The clamp device according to claim 4 wherein the drive unit of the arm drive mechanism comprises an air cylinder.
